(19) United States
(12) Patent Application Publication
(10) Pub. No.: US 2021/0262449 A1
(43) Pub. Date: Aug. 26, 2021

(54) BLADE FOR A ROTOR OF A WIND TURBINE AND MANUFACTURING METHOD THEREOF

(71) Applicant: Siemens Gamesa Renewable Energy Innovation & Technology S.L., Sarriguren (ES)

(72) Inventors: Victor March Nomen, Les Fonts (ES); Olimpio Guerrero Buitrago, Artica (ES); Pilar Izu Belloso, Pamplona (ES)

(21) Appl. No.: 17/177,537

(22) Filed: Feb. 17, 2021

(30) Foreign Application Priority Data
Feb. 21, 2020 (EP) 20380009.9

(51) Int. Cl. F03D 80/40; B29D 99/00

(52) U.S. Cl. CPC F03D 80/40; B29D 99/0025; B29K 2105/0809; F05B 2230/31; F05B 2240/85; F05B 2240/30

(57) ABSTRACT

An anti and/or de-icing blade and manufacturing method for said blade including a pressure side shell and a suction side shell, the shells including at least one electrical connector layer extending from the leading edge towards the trailing edge, at least one heating elements layer electrically in contact with the electrical connector layer, glass fabric layers at least inwardly in contact with the electrical connector or with heating elements layer, a connector component extending transversally through the glass fabric layers and being electrically connected with the electrical connector layer and with a metallic block which is drilled by an inter-connector so that the electrical connector layers from each shell are electrically connected and the blade is able to be heated when electrically fed from power source.

### CROSS-REFERENCE TO RELATED APPLICATIONS

This application claims priority to European Patent Application No. 20380009.9, having a filing date of Feb. 21, 2020, the entire contents of which are hereby incorporated by reference.

### FIELD OF TECHNOLOGY

The following relates generally to wind turbines blades and, more particularly, to an anti and/or de-icing blade and to a manufacturing method for said blade which yields a simpler and cheaper to manufacture anti and/or de-icing blade which is reliable, effective and accurate for blades comprising multiple heating elements.

### BACKGROUND

Wind turbine blades are the core components used by modern wind turbines to capture wind energy. The aerodynamic characteristics of the blades have a crucial impact on the efficiency of wind turbines. When the wind turbine is operated in rainy or snowy weather or in a humid environment during the cold season, ice on the surface of the blade may occur. Icing will change the existing aerodynamic shape of the blade, which will cause harm to the safe operation of the wind turbine. After the surface of the blade freezes, its natural frequency changes, which causes the dynamic response behavior of the blade to change, which will cause interference to the control behavior of the control system. The integrity of the wind turbine structure itself is also affected by the frozen blades. The effects of imbalance or asymmetry increases the fatigue loads of the wind turbine.

By arranging a heating layer on the surface or inner layer of the blade, the blade can be heated to prevent ice from freezing on the surface when ice formation is to occur, or heating can be initiated after the surface has frozen to cause the ice layer on the surface to melt and achieve the purpose of deicing. The heating unit used in the existing heating anti-icing system is either uniformly disposed on the surface of the blade or divided into several heating zones along the length direction.

For anti-icing solutions, the required heat power demand per square meter is different along the blade being lower at shorter radiuses near the root of the blade and higher as the radius approaches the tip of the blade. Likewise, the required heat flux is higher closer to the leading edge and decreases gradually towards the trailing edge.

Furthermore, it may be found that the surface to be heated covers the leading edge until a certain distance towards the trailing edge, and that this distance may not be constant along the blade.

Some solutions are known for heating a blade comprising multiple resistors along the blade longitudinal axis and therebetween the leading edge and the trailing edge, wherein the heating system is installed after the manufacturing and demolding of the blade.

For example, document EP2526292B1 describes a method for connecting resistor electrodes placed at the outer surface with the required wires for injecting the power inside the blade by means of a conductive sheet in contact with a heating mat.

Document EP2715128B1 describes a solution for the electrical connections of carbon fiber heating mats which are to be integrated on a finished blade.

Most of the solutions known may be effective but complicated and costly.

### SUMMARY

A wind turbine blade is disclosed herein with which it has been found that at least the above disadvantages relating to the prior art solutions are mitigated.

More in particular, in a first aspect of the embodiment of the present invention there is provided a wind turbine blade for a rotor of a wind turbine, comprising a profiled contour formed by a pressure side shell and a suction side shell rigidly joined thereof, said blade comprising a blade root, a blade tip, a leading edge and a trailing edge with a chord c extending therebetween, said shells comprising:
at least one electrical connector layer located at a first distance L1 from the blade root and extending the leading edge towards the trailing edge,
at least one heating elements layer electrically in contact with the electrical connector layer, said heating element layer extending in a longitudinal direction therebetween the blade root and the blade tip and more proximate to the leading edge than to the trailing edge,
glass fabric layers at least inwardly in contact with the electrical connector or with the heating elements layer,
a connector component extending transversally through the glass fabric layers and being electrically connected with the electrical connector layer and with a metallic block, power wires extending longitudinally from a power source near the blade root to the connector component being electrically in contact thereof, said power wires located in at least one of the shells,
   wherein the metallic blocks are drilled by an inter-connector so that the electrical connector layers from each shell are electrically connected and the blade is able to be heated by the heating elements layer when electrically fed from the power source.

In an exemplary embodiment, each shell further comprises second glass fabric layers outwardly in contact with the heating elements layer or the electrical connector layer. I.e. the heating elements layer and the electrical connector layer are placed therebetween glass fabric layers.

Said heating element layer may be call also a first heating element layer hereafter.

The first heating element layer may be inwardly or outwardly in contact with the electrical connector layer. i.e. the order in which they are placed within the shell can vary as long as they are electrically in contact.

In another exemplary embodiment, each shell further comprises a second electrical connector layer electrically in contact with the connector component wherein the heating element layer is therebetween the electrical connector layer and the second electrical connector layer.

In yet another exemplary embodiment, the blade comprises a second heating element layer electrically and outwardly in contact with the electrical connector layer of each shell may be placed at the leading edge covering both shells, said second heating element layer extending therebetween the leading edge and the trailing edge and adjacently to the heating element layers previously installed in the mold of both shells.

In this particular embodiment, the first heating element layer before described is applied during manufacturing of the shells and this particular second heating element layer is applied after the pressure shell and suction shell are rigidly joined.

Thus, the heating element more proximate to the leading edge than to the trailing edge aforementioned may be placed after demoulding the blade, but at least the electrical connector layer, the connector component and glass fabrics layers should be placed during the manufacturing process of the shells.

Each shell comprises a plurality of electrical connector layers extending between the blade root and the blade tip beyond distance L1, wherein each electrical connector layer is electrically connected to a corresponding heating element layer and a connector component which in turn is electrically connected to a metallic block and one of the power wires, so that another region of the blade can be heated independently with different heating elements.

In an exemplary embodiment, each shell comprises a plurality of electrical connector layers extending between the blade root and the blade tip beyond distance L1, wherein each electrical connector layer is electrically connected to a corresponding heating element layer and a connector component which in turn is electrically connected to a metallic block and one of the power wires, so that another region of the blade can be heated independently with different heating elements.

In the embodiment above mentioned, a plurality of heating elements layers is placed between the blade root and the blade tip, and each end of said heating elements layers electrical is electrically connected to a corresponding electrical connector layer which in turn is connected to a connector component which in turn is electrically connected to a metallic block and one of the power wires, so that each region of the blade comprising heating elements layer can be heated independently.

The heating element is a carbon fibre with a biaxial structure, ±45° or carbon veil respect to the blade longitudinal direction.

The electrical connector layer may be a copper or aluminum mesh, or any composite materials with metallic additives or wires.

Additionally, said electrical connector layer is 20-400 mm wide and 50-500 μm of thickness.

In a second aspect of the present invention there is provided a method for manufacturing the aforementioned blade, wherein during manufacturing of each shell and before demolding, the method comprises, at least:
placing at least one electrical connector on a mold with the contour profile of the corresponding shell and connect said electrical connector layer to the connector component thereof,
applying glass fabrics layers in a way they are placed inwardly or outwardly in contact with respect to said electrical connector layer, so that if outwardly in contact they are placed in the mold before the electrical connector layer, and if inwardly in contact they are placed in the mold after the electrical connector layer.

In an exemplary embodiment, the method further comprises the step of connecting the metallic block and the power wires to the connector component during manufacturing of each shell.

In another embodiment, the metallic block and the power wires may be also placed after shell infusion and curing.

In an exemplary embodiment, the method further comprises the step of applying a heating element layer electrically in contact outwardly or inwardly to the electrical connector layer, during the manufacturing of each shell and before shell infusion and curing.

In another exemplary embodiment, said heating element layer is placed after the shells have been rigidly joined and after demolding. This embodiment, may comprise applying a plastic adhesive tape in a region on the leading edge during the manufacturing of each shell and before demolding, and after the shells have been rigidly joined together the heating elements layer are placed on the region where the plastic adhesive tape was originally placed, so that they are electrically connected with the electrical connector layer and covering the leading edge with an additional local infusion and curing where the heating elements have been placed at the leading edge region.

Finally, in an exemplary embodiment after the shells have been rigidly joined, the metallic blocks are drilled with the inter-connector, so that the electrical connector layers from each shell are electrically connected and the blade is able to be heated by the heating elements layer when electrically fed from the power source.

Said plurality of different heating elements layers are placed along the blade between the blade root and the blade tip, all the metallic blocks necessary are drilled with inter-connector at every end of the heating elements. The two electrically connected metallic blocks with the inter-connector provide an electrical terminal at each specific radius, so that can be fed by the power wires. It is worthy to mention that each heating element must be electrically connected to the two different wires, so that voltage coming from the blade root and transmitted through the power wires can be applied to all the heating elements.

### BRIEF DESCRIPTION

Some of the embodiments will be described in detail, with reference to the following figures, wherein like designations denote like members, wherein:

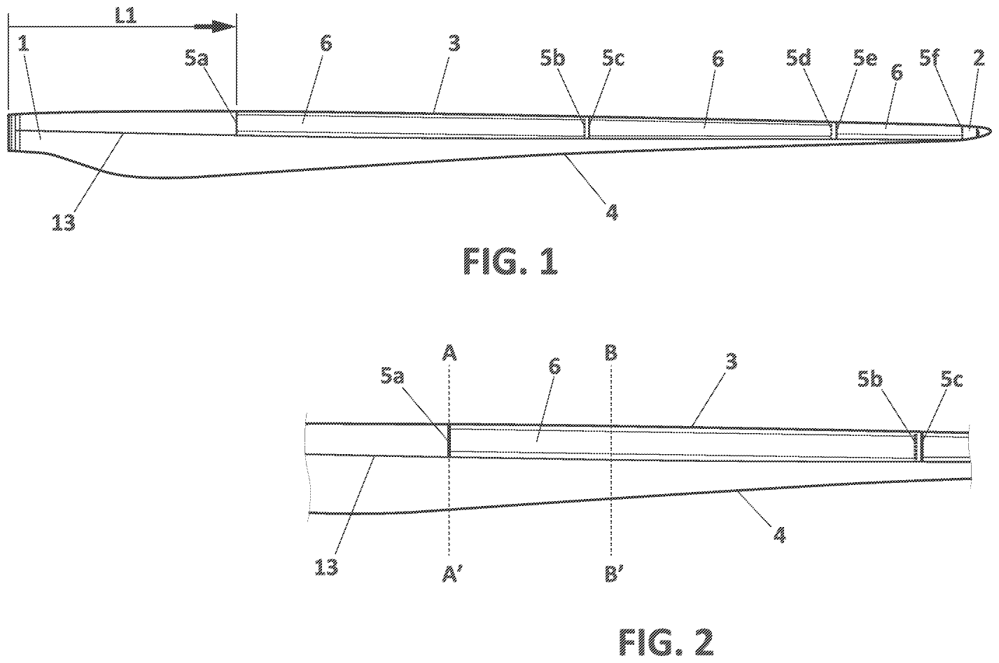

FIG. 1 depicts a front view of an exemplary embodiment of the blade where it can be seen the heating elements layers extending therebetween the blade root and the blade tip;

FIG. 2 depicts a partial view of FIG. 1 illustrating a first cross section at A-A′ and a second cross section B-B′;

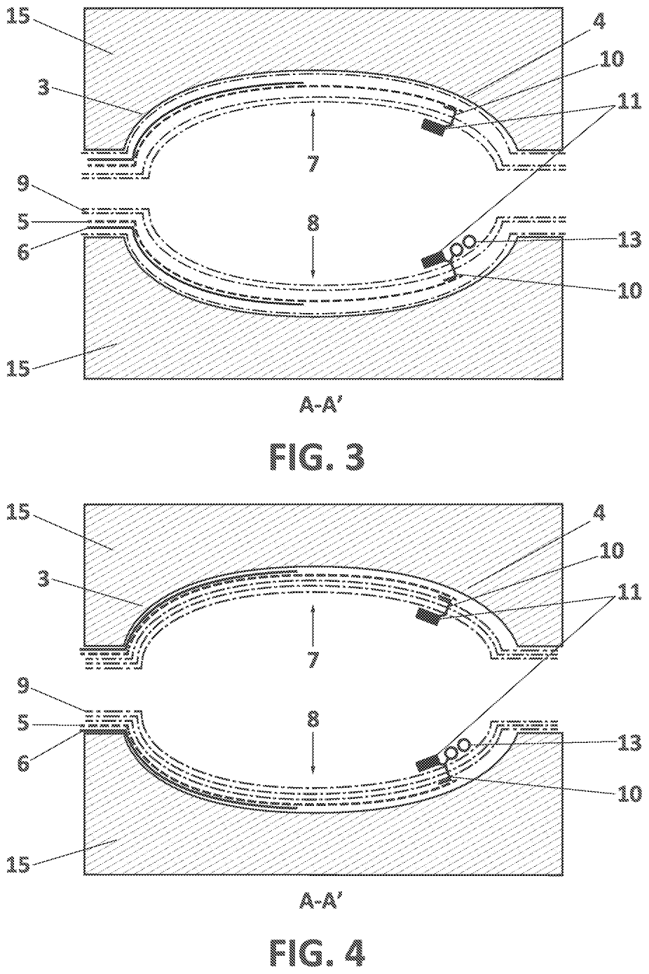

FIG. 3 depicts a detailed view of a first embodiment of a cross section A-A′;

FIG. 4 depicts a detailed view of a second embodiment of a cross section A-A′;

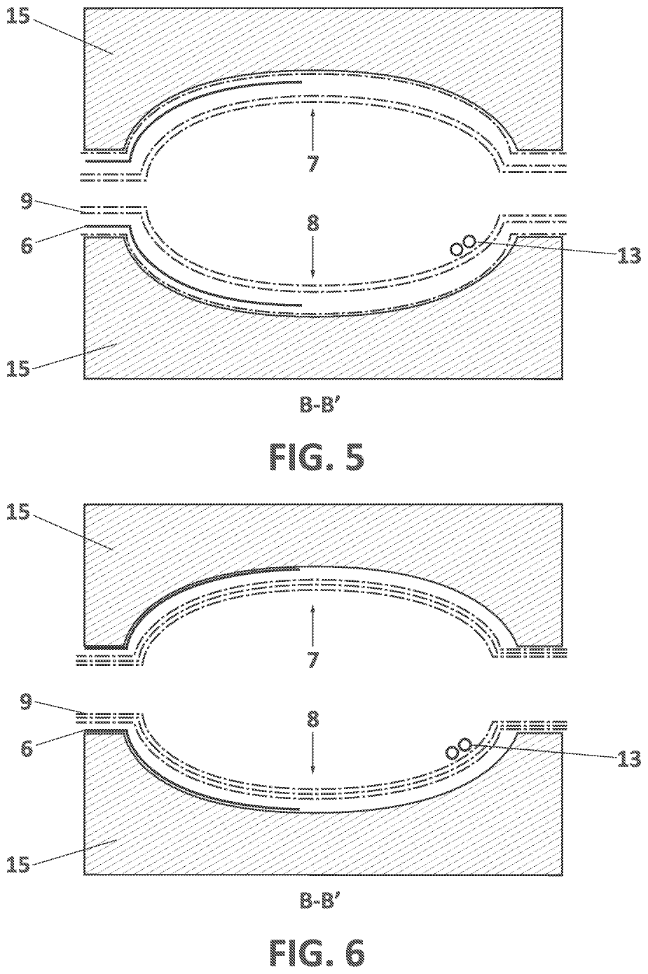

FIG. 5 depicts a detailed view of a first embodiment of the cross section B-B′ represented at FIG. 3;

FIG. 6 depicts a detailed view of a second embodiment of the cross section B-B′ of FIG. 4;

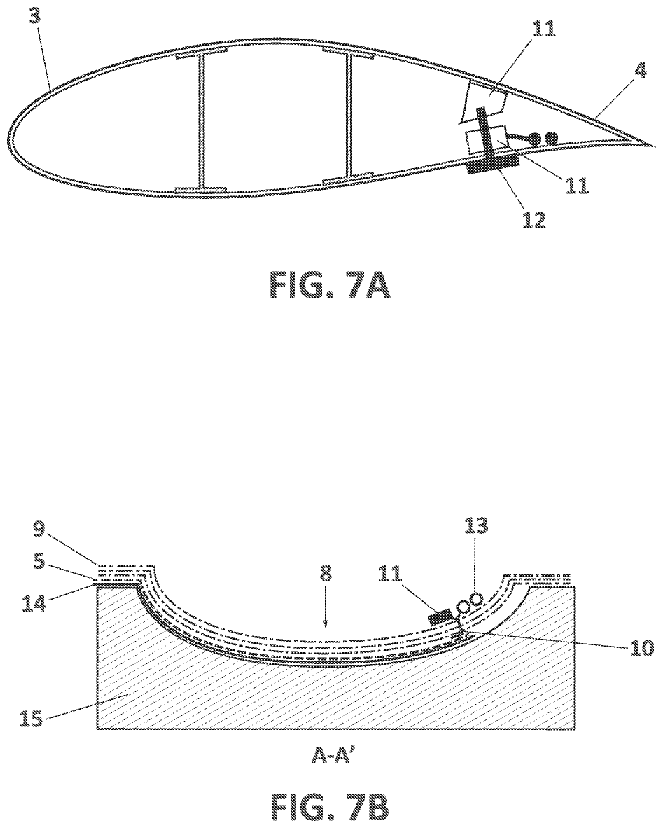

FIG. 7A depicts a cross-sectional side view of an embodiment at section A-A′, clearly showing the metallic blocks (11) drilled by an inter-connector (12);

FIG. 7B depicts a detailed view of a third embodiment of cross section A-A′;

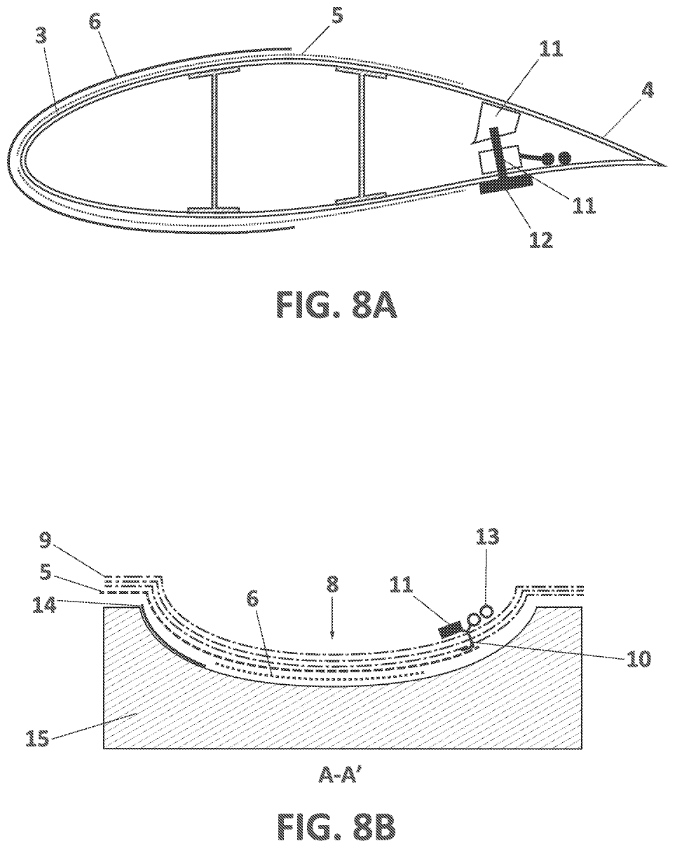

FIG. 8A depicts a cross-sectional side view of a third embodiment at section A-A′ of FIG. 7B;

FIG. 8B depicts a detailed view of a fourth embodiment of a cross section A-A′; and

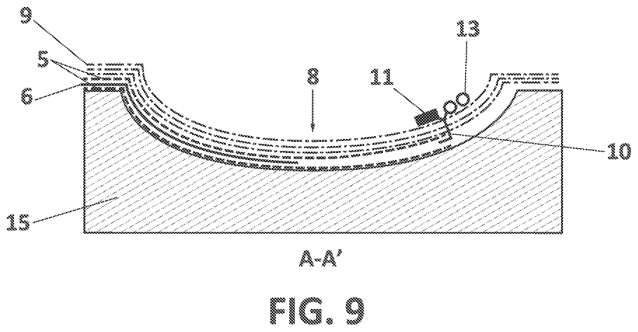

FIG. 9 depicts a detailed view of a fifth embodiment of the cross section A-A′.

### DETAILED DESCRIPTION

What follows is a detailed description, with the help of the attached FIGS. 1-9 referenced above, of an exemplary embodiments of the aspect of the present invention.

The embodiment of the present invention relates to a blade and method of manufacturing of said blade for de-icing or anti-icing purposes.

Firstly, the blade of the present invention is explained below.

In a first aspect of the embodiment of the present invention it is described a blade which can be generally applied to any blade for a wind turbine rotor that involves heating with one or more heating elements.

More in a particular, the blade may comprise, see FIG. 1, a profiled contour formed by a pressure side shell (7) and a suction side shell (8) rigidly joined thereof, further comprising a blade root (1), a blade tip (2), a leading edge (3) and a trailing edge (4) with a chord extending therebetween.

Moreover, each shell may comprise at least one electrical connector layer (5) located at a first distance L1 from the blade root (1) and extending from the leading edge (3) towards the trailing edge (4), at least one heating elements layer (6) electrically in contact with the electrical connector layer (5), wherein said heating element layer (6) extending in a longitudinal direction therebetween the blade root (1) and the blade tip (2) and more proximate to the leading edge (3) than to the trailing edge (4).

Additionally, in several embodiments glass fabric layers (9) are inwardly in contact with the electrical connector layer (5) or with heating elements layer (6)—depending on the arrangement between said layers (5,6) which may be inwardly or alternatively outwardly in contact thereof—and the blade further comprises a connector component (10) extending transversally through the glass fabric layers (9) and being electrically connected with the electrical connector layer (5) and with a metallic block (11).

the blade may further comprise power wires (13) extending longitudinally from a power source near the blade root (1) to the connector component (10) being electrically in contact thereof, said power wires (13) located in at least one of the shells (7,8), and wherein the aforementioned metallic blocks (11) are drilled by an inter-connector (12) so that the electrical connector components (10) from each shell (7,8) are electrically connected and the blade is able to be heated by the heating elements layer (9) when electrically fed from the power source

It should be appreciated that the aforementioned blade may comprise several embodiments with different combination regarding the respective order of the plurality of aforementioned layers.

Additionally, the heating elements layer (6) may be applied during the manufacturing and before infusion and curing or after the pressure shell (7) and the suction shell (8) have been rigidly joined.

In FIG. 1, it is shown as example, a blade comprising three heating elements (6) on one shell. The first having electrical connectors (5a, 5b), for the second being (5c, 5d) and for the third (5e, 5f). One of each electrical connectors for each heating element (6) connected to one power wire (13).

FIG. 2, shows a partial view of the blade of FIG. 1, showing two cross sections, a first cross section A-A′ and a second cross section B-B′. The two electrical connectors (5a, 5b) for heating element (6) shall be connected to two different power wires (13) in order to be fed from a power source.

Referring now to FIG. 3, in a first embodiment each shell (7,8) further comprises second glass fabric layers (9) outwardly in contact with the heating elements layer (6) or the electrical connector layer (5).

Moreover, as can be appreciated in FIG. 3 the heating elements layer (6) is outwardly in contact with the electrical connector layer (5) during the manufacturing of the blade at cross section A-A′. In another embodiment the heating element layer (6) may be inwardly in contact with the electrical connector layer (5).

Referring now to FIG. 4, in a second exemplary embodiment it is shown that the farthest and exterior layer is the heating elements layer (6) in electrical contact with adjacent electrical connector layer (5) inwardly displaced therein.

FIG. 5 illustrates the second section B-B′ of the blade according to the aforementioned first embodiment. It can be clearly appreciated that the electrical connector layer (5) does not extend along all the longitudinal direction of the blade but rather at the connections at the heating elements layer (6) ends, one of them clearly being section A-A′ in FIG. 3. Thus, it is not shown at FIG. 5.

As can be appreciated in FIG. 5, section B-B′ comprises glass fabric layers inwardly and outwardly of the heating element layer (6).

Referring now to FIG. 6 it illustrates second section B-B′ of the blade according to the aforementioned second embodiment. It can be clearly appreciated that the electrical connector layer (5) does not extend along all the longitudinal direction of the blade but rather at the connections at the heating elements layer (6) ends, one of them clearly being section A-A′ in FIG. 6.

As can be appreciated in FIG. 6, section B-B′ comprises glass fabric layers inwardly of the heating element layer (6) farthest exteriorly—closer to the molds (15).

Referring now to FIG. 7A it is therein illustrated a cross-sectional side view at section A-A′, where it is clearly shown the aforementioned metallic blocks (11) are drilled by an inter-connector (12) so that the electrical connector layer (10) from each shell (7,8) are electrically connected and the blade is able to be heated by the heating elements layer (9) when electrically fed from the power source.

Referring now to FIG. 7B and FIG. 8A, it is therein exemplified a third exemplary embodiment wherein the heating element layer (6) its not applied during the manufacturing of each shell (7,8). Rather a plastic adhesive tape (14) is applied farthest towards the exterior, and the heating elements layer (6) is applied after the shells (7,8) have been rigidly joined—see FIG. 8A—. In this FIG. 8A, it is not represented the electrical connection layer (10), which may be electrically connecting the electrical connector layer (5) with the metallic block (11).

FIG. 8B illustrates a fourth embodiment wherein a first heating elements layer (6) is applied during manufacturing extending therebetween the leading edge (3) and the trailing edge (4).

Moreover, in the fourth embodiment it may be applied a plastic adhesive tape (14) in the leading edge which may be not in contact with the first heating elements (6) and after the shells (7,8) have been rigidly joined the plastic adhesive tape (14) may be removed and second heating elements layer (6) may be applied therein in the leading edge (3) in electric contact with the electric connector layer (5).

Referring to FIG. 9 in a yet further embodiment each shell (7,8) may comprise two electrical connector layers (5) wherein the heating elements layer (6) may be in electrical contact with each electrical connector layers (5) and located therebetween.

In an exemplary embodiment the heating element of the heating elements layer (6) may be carbon fiber with a biaxial structure, ±45° respect to the blade longitudinal direction, or carbon veil.

Furthermore, in a further exemplary embodiment the electrical connector layer (5) comprises a copper or aluminum mesh, or any composite materials with metallic additives or wires.

Said electrical connectors may be 20-400 mm wide and 50-500 μm of thickness.

In an exemplary embodiment each shell (7,8) comprises a plurality of electrical connector layers (5a-5f) extending between the blade root (1) and the blade tip (2) beyond distance L1, wherein each electrical connector layer (5a-5f) is electrically connected to a corresponding heating element layer (6) and to a connector component (10) which in turn is electrically connected to a metallic block (11) and power wires (13), so that another region of the blade can be heated independently with different heating elements—see FIG. 1—.

In other words, cross section, A-A′ of any of the several embodiments can be reproduced a plurality of times along the blade longitudinal direction at every end of the heating elements layer (6).

In a second aspect of the present invention it is described a method for manufacturing the blade before described in any of the embodiments, wherein during the manufacturing of each shell (7,8) and before demolding the method comprises, at least:
a) placing one electrical connector layer (5) on a mold with the contour profile of the corresponding shell (7,8) and connect said electrical connector layer (5) to the connector component (10) thereof,
b) applying glass fabrics layers (9) in a way they are placed inwardly or outwardly in contact with respect to said electrical connector layer (5), so that if outwardly in contact they are placed in the mold before the electrical connector layer (5), and if inwardly in contact they are placed in the mold after the electrical connector layer (5).

In an exemplary embodiment the method further comprises the step of connecting the metallic block (11) and the power wires (13) to the connector component (10) before or after the infusion and curing of each shell (7,8).

Moreover, in an exemplary embodiment the method further comprises the step of applying a heating element layer (6) electrically in contact outwardly or inwardly to the electrical connector layer (5), during the manufacturing of each shell (7,8) and before their infusion and curing.

In another embodiment, the method comprises the step of applying a plastic adhesive tape (14) in a region on the leading edge (3) during the manufacturing of each shell (7,8) and before demolding, and after the shells (7,8) have been rigidly joined together apply a heating elements layer (6) on the region where the plastic adhesive tape (14) was originally placed.

Finally, after the shells (7,8) have been rigidly joined, the metallic blocks (13) may be drilled with the inter-connector (12) so that the electrical connector layers (10) from each shell (7,8) are electrically connected and the blade is able to be heated by the heating elements layer (6) when electrically fed from the power source.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

What is claimed:

1. A blade for a rotor of a wind turbine, comprising a profiled contour formed by a pressure side shell and a suction side shell rigidly joined thereof, the blade comprising a blade root, a blade tip, a leading edge and a trailing edge with a chord extending therebetween, the pressure side shell and the suction side shell comprising:
at least one electrical connector layer located at a first distance from the blade root and extending from the leading edge towards the trailing edge;
at least one heating elements layer electrically in contact with the electrical connector layer, the at least one heating element layer extending in a longitudinal direction therebetween the blade root and the blade tip and more proximate to the leading edge than to the trailing edge;
glass fabric layers at least inwardly in contact with the electrical connector or with the at least one heating elements layer;
a connector component extending transversally through the glass fabric layers and being electrically connected with the electrical connector layer and with a metallic block; and
power wires extending longitudinally from a power source near the blade root to the connector component being one of the power wires electrically in contact thereof, the power wires located in at least one of the suction side shell and the pressure side shell
wherein the metallic block is drilled by an inter-connector so that the electrical connector layers from the suction side shell and the pressure side shell are electrically connected and the blade is able to be heated by the at least one heating elements layer when electrically fed from the power source.

2. The wind turbine blade of claim 1, wherein each of the suction side shell and the pressure side shell further comprises second glass fabric layers outwardly in contact with the at least one heating elements layer or the electrical connector layer.

3. The wind turbine blade of claim 1, wherein the at least one heating elements layer is outwardly in contact with the electrical connector layer.

4. The wind turbine blade of claim 1, wherein the at least one heating elements layer is inwardly in contact with the electrical connector layer.

5. The wind turbine blade of claim 4, comprising a second electrical connector layer electrically and outwardly in contact with the electrical connector layer and alternatively also being electrically in contact with the connector component.

6. The wind turbine blade of claim 1, wherein each of the suction side shell and the pressure side shell further comprises a second heating element layer electrically and outwardly in contact with the electrical connector layer, the second heating element layer extending therebetween the leading edge and the trailing edge and adjacently to the at least one heating element layer.

7. The wind turbine blade of claim 1, wherein each of the suction side shell and the pressure side shell comprises a plurality of electrical connector layers extending between the blade root and the blade tip beyond distance, wherein each electrical connector layer is electrically connected to a corresponding heating element layer and a connector component which in turn is electrically connected to a metallic block and one of the power wires, so that another region of the blade can be heated independently with different heating elements.

8. The wind turbine blade of claim 1, wherein a heating element is a carbon fibre with a biaxial structure, ±45° respect to the blade longitudinal direction, carbon veil or any composite fabric including conductive components.

9. The wind turbine blade of claim 1, wherein the electrical connector is a copper or aluminum mesh, or any composite materials with metallic additives or wires.

10. The wind turbine blade of claim 1, wherein the electrical connector is 20-400 mm wide and 50-500 μm of thickness.

11. A method for manufacturing the blade of claim 1, wherein during manufacturing of each of the suction side shell and the pressure side shell the method comprising:
placing one electrical connector layer on a mould with the contour profile of the corresponding shell and connect the electrical connector layer to the connector component thereof; and
applying glass fabrics layers in a way that the glass fabrics layers are placed inwardly or outwardly in contact with respect to the electrical connector layer, so that if outwardly in contact the glass fabrics layers are placed in the mould before the electrical connector layer, and if inwardly in contact the glass fabrics layer are placed in the mould after the electrical connector layer.

12. The method for manufacturing of claim 11, comprising the step of installing and/or connecting the metallic block and the power wires to the connector component during or after the manufacturing of each shell.

13. The method for manufacturing of claim 11, comprising the step of applying the at least one heating element layer electrically in contact outwardly or inwardly to the electrical connector layer, during the manufacturing of each of the suction side shell and the pressure side shell and before shell infusion and curing.

14. The method for manufacturing according to claim 11, further comprising the step of applying a plastic adhesive tape in a region on the leading edge during the manufacturing of each of the suction side shell and the pressure side shell and before demoulding, and after the suction side shell and the pressure side shell have been rigidly joined together apply the at least one heating elements layer on the region where the plastic adhesive tape was originally placed.

15. The method for manufacturing according to any claim 11, wherein after the suction side shell and the pressure side shell have been rigidly joined, the metallic blocks are drilled with the inter-connector.
